(19) United States
(12) Patent Application Publication
(10) Pub. No.: US 2006/0177080 A1
(43) Pub. Date: Aug. 10, 2006

(54) Earpiece with flanged extension

(76) Inventor: Richard C. Smith, Costa Mesa, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/247,105

(22) Filed: Oct. 11, 2005

Related U.S. Application Data
(60) Provisional application No. 60/646,909, filed on Jan. 25, 2005.

(51) Int. Cl. H04R 25/00

(52) U.S. Cl. 381/313

(57) ABSTRACT

An earpiece having at least one flanged extension is disclosed. The earpiece can be used to mitigate exposure to ambient sound. The earpiece can also be used to provide sound from a two-way radio or the like to a user's eardrum. Combinations of these two applications are possible. Thus, ambient sound can be attenuated while sound from a radio is enhanced. A controlled amount of ambient sound can be allowed to reach a user's eardrum. This may be desirable, for example, when it is necessary for a user to hear conversations or other comparatively lower lever sounds.

### PRIORITY CLAIM

This patent application claims the benefit of the priority date of U.S. provisional patent application Ser. no. 60/646,909, filed on Jan. 25, 2005, and entitled EARPIECE WITH FLANGED EXENSION (docket no. M-15744-V1 US) pursuant to 35 USC 119. The entire contents of this provisional patent application are hereby expressly incorporated by reference.

### BACKGROUND

Hearing protection for use in noisy environments is well known. Hearing protection is commonly used in such noisy environments as manufacturing facilities, warehouses, construction sites, shooting ranges, battlefields, and airports. Typically, any time that loud machinery is being operated, guns are being fired, or any other source of excessive noise is present, hearing protection is desirable so as to reduce discomfort and so as to conserve hearing. Contemporary hearing protection typically comprises either a noise reducing headset or earplugs.

Although headsets are generally effective in reducing noise exposure, they suffer from deficiencies that tend to make them unsuitable for some applications. Headsets are bulky. They cannot be worn in environments where they may get in the way and they cannot be worn under helmets.

Additionally, headsets tend to become uncomfortable after being worn for an extended period of time. Because of this, wearers may discontinue their use while they remain within a noisy environment. Wearers may alternatively stretch the earpieces of the headset apart from one another, so that they do not apply as much pressure to the sides of the head. However, when the pressure is reduced in this manner, then the earpieces may not seal properly and thus may permit the introduction of excessive sound. In either instance, noise exposure is undesirably increased.

Earplugs can also be effective. However, they can similarly become uncomfortable when worn for extended periods of time. Further, earplugs tend to work loose during usage, thus reducing their effectiveness. They may even fall out.

Law enforcement, security, and military personnel frequently wear earpieces that fit into the conchae bowl of the ear and facilitate listening to two-way radios and the like. Such earpieces are different from earplugs in that they are intended to allow some sound to enter the ear. These earpieces are attached via acoustic tubing to a small speaker. Communications received by a two-way radio are reproduced by the speaker. Sound then travels through the acoustic tubing to the user's ear, where the end of the acoustic tubing is held in place by the earpiece.

Further, the sound output port or opening of such contemporary earpieces is further away from the eardrum than is sometimes desirable. Such positioning of the sound output port necessitates that the volume of the speaker be increased more than would be required if the sound output port were closer to the eardrum. When the volume of the speaker is increased, the likelihood of another person hearing the communication is undesirably increased.

Although such contemporary earpieces are generally suitable for their intended purposes, they suffer from inherent deficiencies that tend to detract from their overall usefulness. For example, during covert operations it is usually desirable to for a wearer to remain unobtrusive. Thus, it is undesirable for others to be able to hear the wearer's radio.

Additionally, in some instances the speaker may be incapable of delivering the desired volume. This is particularly true where the earpiece is being used by the hearing impaired or in a noisy environment. It may also be true when the speaker simply lacks sufficient output power.

Thus, it is desirable to provide an earpiece that provides protection from noise exposure while being comfortable to wear for extended periods of time and while not tending to work its way loose or otherwise become less effective. It is also desirable to provide an earpiece that provides sound closer to the eardrum, so that the sound produced by the speaker is more easily heard and so that reduced volume can be advantageously utilized, such as in covert situations.

### SUMMARY

A device for mitigating sound exposure and/or facilitating communication is disclosed. According to one embodiment of the present invention, the device comprises an earpiece and an extension formed to the earpiece. The extension can be solid, so as to mitigate sound exposure. The extension can alternatively have a bore formed therethrough, with a sound output port that is configured to be positioned proximate a user's eardrum when the earpiece is worn, so that sound is more effectively provided to the eardrum and consequently the volume of a two-way radio or the like can be substantially reduced. The device can be configured so as to mitigate undesirable exposure to harmful ambient sound while allowing desirable ambient sound (such as conversations) to be heard.

More particularly, the device can comprise an earpiece that is configured to be disposed at least partially within a conchae and an extension that is formed to the earpiece, wherein the extension is configured to be disposed at least partially within an ear canal. The extension can comprise one or more flanges. Each flange tends to seal the ear canal so as to mitigate the communication of sound therethrough in either direction. Thus, protection from excessive ambient sound is provided to the wearer and the ability for others to hear radio communications is mitigated.

A filter, such a Hoch filter, can be placed in acoustic communication with a bore of the extension so as to help determine what sounds are communicated to a wearer's eardrum. For example, the filter can be placed within the extension, proximate where the extension attaches to the earpiece.

The earpiece and the extension can be configured for use in a human ear. Alternatively, the earpiece and the extension can be configured for use in a non-human ear. For example, the earpiece and the extension can be configured for use in a canine ear, so as to provide hearing protection for the canine and/or so as to facilitate the use of radio voice command for the canine.

According to at least one embodiment, the earpiece comprises a generally arcuate rib having upper and lower ends and a generally straight rib extending substantially between the upper and lower ends. An upper lobe can be formed at the upper end of the arcuate rib and a lower lobe can be formed at the lower end of the arcuate rib. The earpiece is configured to be captured by protrusions of the conchae.

The arcuate rib can be configured so as to bend in order to accommodate a large range of ear sizes. For example, the earpiece can be configured to fit at about 70% of the ears of men between 19 and 40 years old.

This invention will be more fully understood in conjunction with the following detailed description taken together with the following drawings.

### BRIEF DESCRIPTION OF THE DRAWINGS

FIG. 1 is a perspective view of an earpiece having a flanged extension according to a first embodiment of the present invention;

FIG. 2 is a perspective view of the extension of the earpiece of FIG. 1 wherein the extension is removed from the earpiece;

FIG. 3 is a perspective view of one alternative embodiment of the extension of FIG. 2, wherein openings are formed in the flanges thereof;

FIG. 4 is a perspective view of another alternative embodiment of the extension of FIG. 2, wherein openings are formed in the stem thereof;

FIG. 5 is a perspective view of the extension of FIG. 2, showing a Hoch's filter inserted therein;

FIG. 6 is a side view of the earpiece of FIG. 1, wherein the extension is removed therefrom;

FIG. 7 is a bottom view of the earpiece of FIG. 6, showing the aperture therein with dashed lines;

FIG. 8 is a perspective view of an earpiece having a flanged extension according to a second embodiment of the present invention;

FIG. 9 is a perspective view of the extension of the earpiece of FIG. 8 wherein the extension is removed from the earpiece;

FIG. 10 is a perspective view of the earpiece of FIG. 1 having acoustic tubing attached thereto; and

FIG. 11 is a perspective view of the flanged extension of FIG. 1, showing the Hoch filter exploded therefrom and also showing a flexible skin (dashed lines) formed partially thereover.

Embodiments of the present invention and their advantages are best understood by referring to the detailed description that follows. It should be appreciated that like reference numerals are used to identify like elements illustrated in one or more of the figures.

### DETAILED DESCRIPTION OF THE PREFERRED EMBODIMENTS

The present invention comprises an earpiece with a flanged extension that is suitable for use as hearing protection, is suitable for facilitating listening to a two-way radio or the like, or is suitable for providing a combination of hearing protection and such listening. The present invention may comprise a solid extension so as to substantially attenuate ambient sound. Alternatively, the present invention may comprise a hollow or partially hollow extension so allow at least some ambient sound or sound from a radio to pass therethrough.

Various combinations of attenuation and transmission may be provided. For example, a hollow or partially hollow extension may be configured so as to substantially attenuate some ambient sound (such as potentially harmful loud noise), while allowing some ambient sound (such as voices) to be heard. Optionally, the extension can comprise one or more openings that allow a substantial portion of ambient sound to be heard, while also allowing radio communications to be heard. Optionally, a filter may be used to selectively allow sounds to be heard.

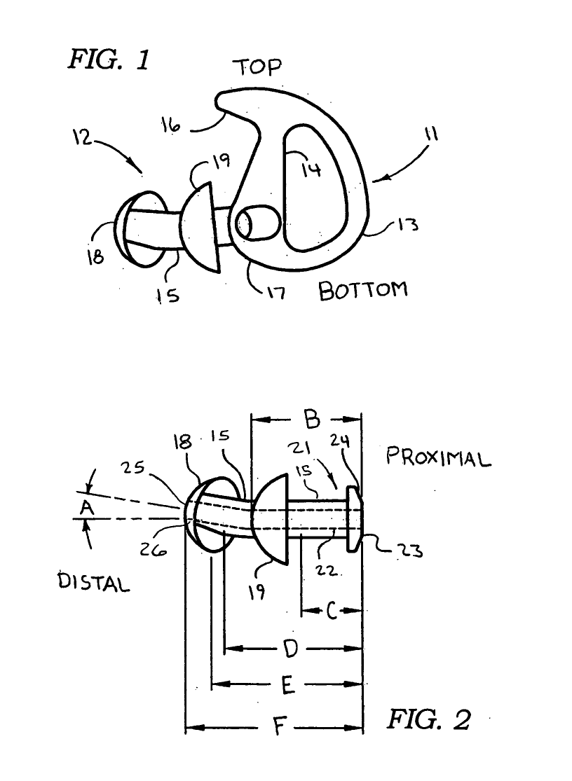

Referring now to FIGS. 1, 2, 6, and 7, one embodiment of the present invention comprises an earpiece 11 to which an extension 12 is attached. Earpiece 11 is configured to be disposed in the conchae of the outer ear. Extension 12 is configured to be disposed within the ear canal.

Earpiece 11 can comprise a generally arcuate rib 13 that has upper and lower ends. Arcuate rib 13 can be attached to a straight rib 14 at the upper and lower ends of arcuate rib 13. An upper lobe 16 can be formed proximate where arcuate rib 13 and straight rib 14 join at the top of earpiece 11. Similarly, a lower lobe 17 can be formed proximate where arcuate rib 13 and straight rib 14 join at the bottom of earpiece 11.

Earpiece 11 is configured to be disposed and held in place within the conchae of a human ear. More particularly, the crus and the antihelix of a wearer's ear cooperate to capture upper lobe 16 and the tragus and antitragus cooperate to capture lower lobe 17. The antihelix and the antitragus cooperate to capture arcuate rib 13. Thus, earpiece 11 is configured to be captured by protrusions of the conchae. In this manner, earpiece 11 is held firmly in place within the conchae and can therefore maintain extension 12 in a desired position within the ear canal.

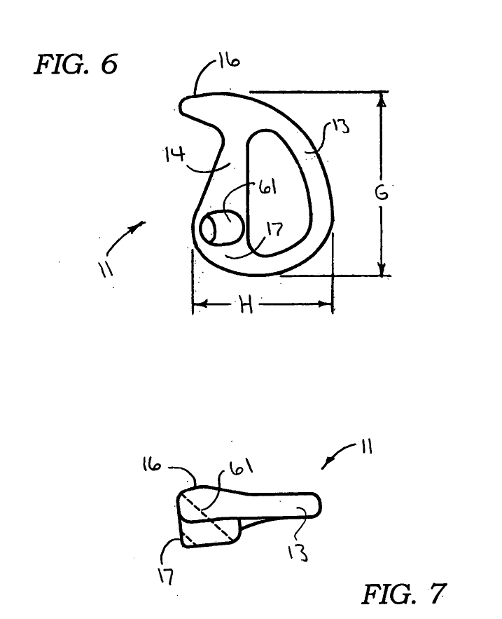

Extension 12 can be either removably or permanently attached to earpiece 11. Extension 12 can be removably attached to earpiece 11 by friction fit, by detents, by threads, or by any other desired means. For example, extension 12 can be friction fit to earpiece 11 by sizing a proximal portion 21 (FIG. 2) of extension 12 so as fit tightly within an aperture 61 (FIG. 6) of earpiece 11.

Extension 12 can be permanently attached to earpiece 11 by adhesive bonding, ultrasonic welding, or by any other desired means. Alternatively, extension 12 can be integrally formed to earpiece 11, such as by injection molding earpiece 11 and extension 12 within a common mold cavity. Thus, earpiece 11 and extension 12 can be formed either integrally or separately.

Earpiece 11 and extension 12 can be formed of a soft, resilient material to enhance comfort during use. Both earpiece 11 and extension 12 can be formed of the same material. For example, earpiece 11 and extension 12 can be formed of a resilient polymer, such as silicon rubber. Earpiece 11 and extension 12 can be formed of a material having a Shore A durometer of between 35 and 45, such as a Shore A durometer of approximately 40.

Earpiece 11 functions as a stop to prevent extension 12 from being inserted too far into the ear. Earpiece 11 also prevents extension 12 from being inadvertently removed or loosened from the ear. The length of extension 12 determines, at least in part, how close the tip thereof is positioned with respect to the eardrum.

With particular reference to FIG. 2, according to one embodiment of the present invention extension 12 comprises a stem 15 and two flanges, 18 and 19. Extension 12 can comprise any desired number of flanges, including no flanges at all, as discussed in further detail below. Stem 15 can either be solid (so as to substantially block sound) or hollow (so as to substantially transmit sound). Stem 15 can also be partially hollow (so as to selectively transmit sound).

Stem 15 can bend such that it angles upwardly to conform to the upward angle of the human ear canal. For example, stem 15 can bend such that it angles upwardly at an angle, Angle A, of approximately 30°. The distance between the proximal end of extension 12 and the distal end of outer flange 19, Dimension B, can be approximately 0.545 inch. The distance between the proximal end of extension 12 and the point where a filter (such as a Hoch filter) ends, Dimension C, can be approximately 0.304 inch. The distance between the proximal end of extension 12 and the bend in stem 15, Dimension D, can be approximately 0.680 inch. The distance between the proximal end of extension 12 and a distal end of inner flange 18, Dimension E, can be approximately 0.743 inch. The distance between the proximal end of extension 12 and the distal end of inner flange 18, Dimension F, can be approximately 0.870 inch.

The diameter of stem 15 can be approximately 0.189 inch. Stem 15 can optionally have a bore 22 formed therethrough. Bore 22 can have a diameter of approximately 0.094 inch. Outer flange 19 can have a radius of approximately 0.241 inch. Similarly, inner flange 18 can have a radius of approximately 0.193 inch. Thus, the radius of inner flange 18 can be substantially less than the radius of outer flange 19, so as to better accommodate the manner in which the human ear canal becomes narrower as it gets deeper.

The exemplary angle and dimensions discussed above provide a single extension that is suitable for use with a large number individuals. Those skilled in the art will appreciate that other dimensions are likewise suitable.

The distal end of bore 22 defines a sound output port 26 (FIGS. 2 and 9). Extension 12 is configured such that sound output port 26 is positioned proximate the wearer's eardrum. That is, extension 12 can be configured so as to position a distal end 25 thereof proximate the eardrum. In this manner, sound transmitted through bore 22 (such as sound from a two-way radio), is brought close to the eardrum such that the volume of the sound required can be substantially reduced. For example, the extension can position sound output port 26 within one, two, or three millimeters of the eardrum. The extension can have a length of approximately ½ inch. The extension can have a length of ⅝ inch or more.

A head 23 can be formed upon the proximal end of stem 15 so as to enhance friction with respect to aperture 61 of earpiece 11 and/or so as to define detents that tend to keep extension 12 attached to earpiece 11. Bevels 24 can optionally be formed upon head 23 to better facilitate insertion of head 23 through aperture 61.

The extension may comprise a flanged extension, having flanges as shown in FIGS. 2-5 and 8-11. The flanges generally fill (close off) the ear canal and tend to block ambient sound. Although sometimes it is desirable to block ambient sound, other times, it is desirable for the user to hear ambient sound. Thus, the flanges can have opening formed therein, as discussed below. Although two flanges are shown, the extension may comprise more or less flanges. For example, the extension may comprise three, four, five, six, or more flanges. The flanges need not be identical, but rather may vary in size, shape, orientation and/or positions of attachment to the stem, for example.

The extension can have a bore formed therethrough to facilitate the transmission of sound from a speaker (such as via acoustic tubing connected to the speaker) to the user's eardrum. Alternatively, the extension can lack such a bore, so as to define an earplug, such as for attenuating ambient sound. Indeed, the bore and/or openings in the stem and/or flanges can be configured so as to selectively transmit and block desired sounds. Such selectivity can be based upon the frequency and/or intensity of the sound.

A user can wear one earpiece having an extension with a bore and one earpiece lacking a bore. The earpiece having an extension with a bore facilitates listening to a radio, while the earpiece having an extension without a bore at least partially blocks distracting and/or potentially harmful ambient sound.

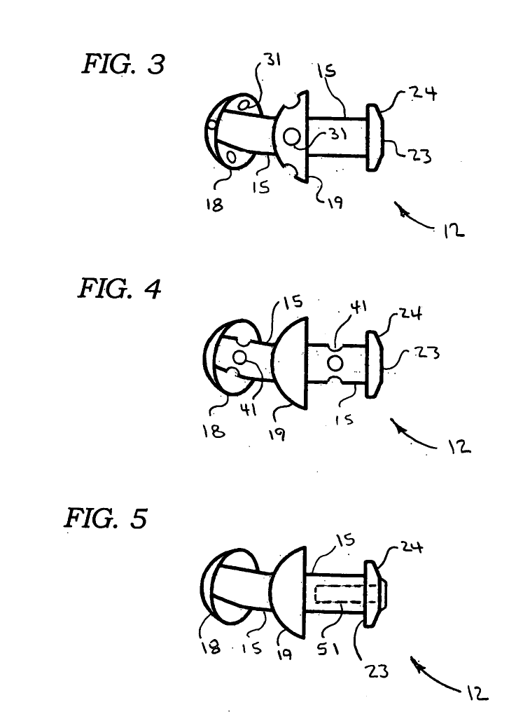

Referring now to FIG. 3, flanges, 18 and 19, of extension 12 can optionally have one or more openings 31 form therein. For example, each flange, 18 and 19, can have one, two, three, or four openings 31 formed therein. Openings 31 can be holes. Alternatively, the openings 31 can be cutouts, such as notches formed in the flanges. The openings allow at least some ambient sound to better reach the user's eardrum.

Such openings 31 may be desirable when the present invention is intended to facilitate listening to a two-way radio and when it is also desirable to hear ambient sound. For example, such openings 31 may be desirable in police applications where a police officer is required to hear both the two-way radio and face-to-face conversations.

Referring now to FIG. 4, one or more openings 41 can be formed in stem 15, such as intermediate or proximate flanges, 18 and 19. A curable polymer material suitable for use in the ear canal can be injected into the tube such that it substantially fills the tube and/or at least some space between the flanges. That is, the injected polymer material extrudes from the openings and tends to fill in the space intermediate the flanges. This injection may be accomplished with the extension inserted into a wearer's ear canal, so as to provide a custom fit. Alternatively, this injection may be performed using an artificial ear canal, such as for mass production.

Silicon rubber may be used as the extrudeable material. Generally, any extrudeable material suitable for use as earplugs can be used. In this fashion, attenuation of ambient sound is enhanced. Such earplugs are suitable for use in gun ranges and noisy industrial environments.

The opening at the distal end of the tube can optionally be closed to prevent leakage of the injected polymer material therefrom. A skin may be formed over the flanged extension to trap the polymer material and/or to facilitate easier insertion into the ears. Alternatively, the openings can be omitted and the central bore of the tube can still be filled with polymer material to attenuate sound.

Referring now to FIG. 5, a filter 51 can be inserted into bore 22 to selectively mitigate sound exposure. For example, a Hoch filter can be used to mitigate exposure to louder sounds, while still allowing a wearer to hear quieter sounds, such as speech.

Referring now to FIGS. 6 and 7, an earpiece 11 that is configured for use in the left ear is shown with the extension removed therefrom. Arcuate rib 13 and straight rib 14 define a D shape. When a mirror image arcuate rib and straight rib are configured for use in the right ear, a reverse (mirror image) D is similarly defined.

For a medium size earpiece, the height, Dimension G, can be approximately 1.087 inch and the width, Dimension H, can be approximately 0.802 inch. For a large size earpiece, the height, Dimension G, can be approximately 1.150 inch and the width, Dimension H, is approximately 0.850 inch. The medium size fits a large percentage of people.

The medium size earpiece can be configured to fit most adult ears. More particularly, the medium size earpiece can be configured to fit at least 70% of ears of men between 19 and 40 years old. Arcuate rib 13 tends to deform or bend so as to accommodate a wide range of ear sizes.

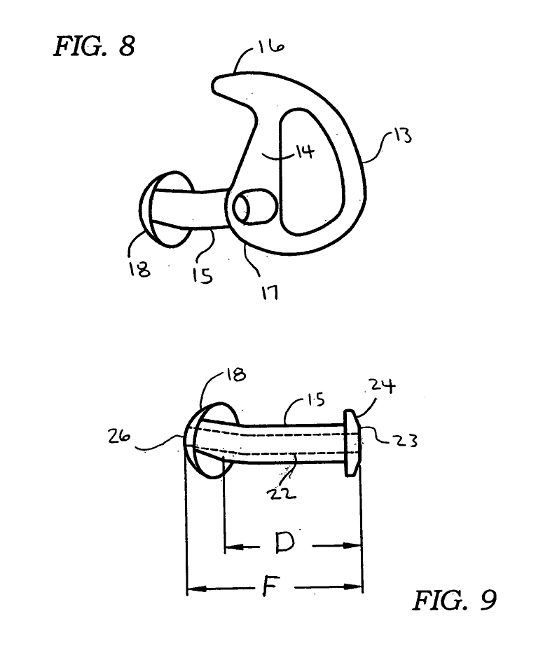

Referring now to FIGS. 8 and 9, outer flange 19 can optionally be omitted. Indeed, as mentioned above, extension 15 can comprise any desired number of flanges, including no flanges. In some instances, a single flange may perform adequately. This is particularly true when it is desirable to allow the wearer to hear ambient sound. Omitting the other flange(s) better allows ambient sound to be heard. In some applications, the primary reason for wearing the earpiece may be to allow the wearer to better hear radio communications. Positioning output port 26 close to the eardrum accomplishes this goal.

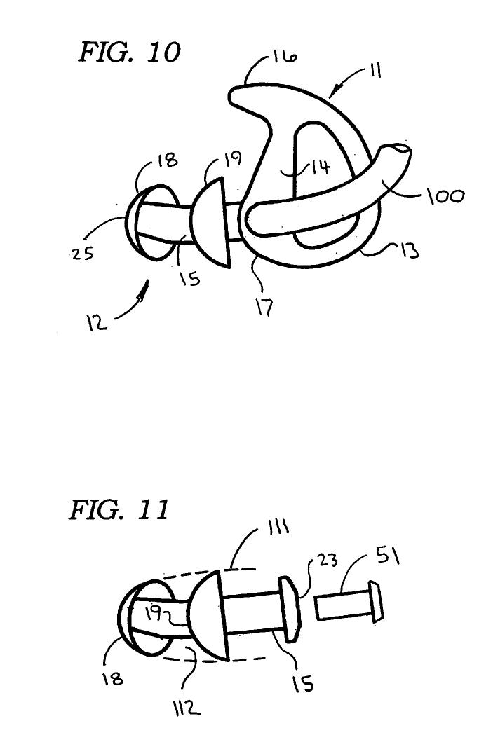

Referring now to FIG. 10, an acoustic tube 100 can be attached to earpiece 11 and/or extension 12 such that a generally continuous bore is defined for sound to travel though from a speaker to the eardrum. A barbed metal or plastic fitting can be used to accomplish such attachment. Other methods of attachment, such as the use of adhesive bonding and/or ultrasonic welding, are likewise suitable.

Since the distal end 25 of extension 12 can be placed close to a wearer's eardrum, the volume of a two-way radio or other device (such as a cellular telephone, CD player, MP3 player, etc.) can be substantially reduced. With the volume reduced, sound advantageously cannot be as easily heard by others. Thus, during covert operations, for example, the likelihood of someone other than the wearer undesirably hearing sound from a two-way radio is substantially mitigated. By reducing the sound volume, smaller, less powerful, and/or less expensive speakers can be used. Placing the sound closer to the eardrum can make it easier for the hearing impaired to hear.

Sound transmissive embodiments of the present invention (such as those embodiments having a bore 22 formed through stem 15) can similarly be used with a variety of personal electronic devices that produce sound, including two-way radios, cellular telephones, MP3 players, CD players, cassette players, personal digital assistants (PDAs), desktop computers, laptop computers, notebook computers, pocket PCs, and hearing aids.

Referring now to FIG. 11, according to another embodiment of the present invention extension 15 comprises one or more flanged members, 18 and 19 (similar to those of FIGS. 5, 6, and/or 7), having a skin or covering 111 formed thereover. Covering 111 can be formed of a thin resilient material, such as rubber, such as that which common balloons are formed of. Optionally, foam or gel 112 can be disposed between the covering 111 and flanged members 18 and 19. Foam or gel 112 can comprise a biocompatible material, such as a silicon. Foam or gel 112 can extend proximal of outer flange 19, if desired.

Foam or gel can be injected between covering 111 and flanged members, 18 and 19, through openings 41 (FIG. 4), as discussed above. Thus, such a covering 111 can be used with extension 12 shown in FIG. 4, where an extrudeable substance (which can be a foam or gel) is injected into bore 22 and passes through holes 21 to fill the void between the flanges, 18 and 19.

Thus, according to at least one embodiment of the present invention the extension can comprise a tube (such as stem 15) and a rubber skin or covering, wherein foam, gel, or some other resilient substance is disposed between the tube and the rubber skin. The present invention can optionally comprise one or more flanges. The tube can be formed of a flexible polymer material. However, the tube may alternatively be formed of a rigid polymer or metal material. The tube, foam, and skin can be attached to one another via any desired combination of friction fitting, adhesive bonding, and ultrasonic welding. The extension can be tapered to facilitate easy insertion into the ear canal and to provide a good fit therein.

One advantage of having more flanges is that the device is better secured in the ear. Another advantage of having more flanges, particularly if the flanges do not have holes formed therein, is that ambient sound is better mitigated before reaching a wearer's eardrum. Another advantage of having more flanges, particularly if the flanges do not have holes formed therein, is that the sound of the radio is better prevented from escaping from the ear, such that it may be undesirably heard by others.

Any of the flanged extensions disclosed herein can either be ambidextrous (formed to fit either the right or left ear), or can be dedicated to fit only one ear. Thus, the flanges can be either radially symmetric or can be asymmetric such that they tend to be optimized for a particular ear (left or right). They can also be optimized in configuration so as to better fit a particular person's ear.

According to one aspect, earpiece 11 is configured to fit multiple sizes of ears. More particularly, arcuate rib 13 is deformable so as to permit earpiece 11 to fit into smaller conchae bowls.

The hole 61 (FIG. 6) in earpiece 11 can be configured such that the flanged extension is positioned at the top of the ear canal, at the bottom of the ear canal, at one side of the ear canal, or is approximately centered in the ear canal. Configuring the hole such that the flanged extension is not approximately centered causes the flanged extension to be biased toward an inner surface of the ear canal and can help to keep the earpiece and extension in the ear.

However, as long as the earpiece and/or the flanges of the insert are sufficient to keep the earpiece and extension in the ear, then the flanged extension can be position approximately in the center of the ear canal. Positioning the flanged extension approximately in the center of the ear canal may be more comfortable for some wearers.

Although described herein a being for use in human ears, one or more embodiment of the present invention can also be used in non-human ears. For example, the present invention can be configured for canine ears, so as to mitigate noise exposure and or facilitate communication with police or military dogs. As those skilled in the art will appreciate, such dogs are commonly exposed to noisy environments, such as those environments sometimes encountered in police work and on the battlefield. Further, it is frequently desirable to communicate with such dogs. Their ability to respond to radio commands has been established.

Thus, one or more embodiments of the present invention can mitigate noise exposure and/or facilitate communications. Noise exposure is mitigated by at least partially blocking the ear canal with an extension from an earpiece. Communications are facilitated by providing a passage for sound through the extension. The extension extends to a point proximate the eardrum, so that sound is delivered more directly to the eardrum. Thus, less volume is needed. The use of less volume is useful in covert operations. As stated above, it may also facilitate the use of smaller, less powerful, and/or less expensive speakers.

Embodiments described above illustrate, but do not limit, the invention. It should also be understood that numerous modifications and variations are possible in accordance with the principles of the present invention. Accordingly, the scope of the invention is defined only by the following claims.

1. A device comprising an earpiece and an extension formed to the earpiece, the extension having a sound output port that is configured to be positioned proximate a user's eardrum when the earpiece is worn.

2. A device comprising:
an earpiece configured to be disposed at least partially within a conchae; and
an extension formed to the earpiece and configured to be disposed at least partially within an ear canal.

3. The device as recited in claim 2, wherein the extension comprises at least one flange.

4. The device as recited in claim 2, wherein the extension comprises one flange.

5. The device as recited in claim 2, wherein the extension comprises two flanges.

6. The device as recited in claim 2, wherein the extension comprises at least one flange having at least one opening formed in the flange to enhance transmission of ambient sound to an eardrum.

7. The device as recited in claim 2, wherein the extension comprises a stem having at least one opening formed.

8. The device as recited in claim 2, wherein the earpiece and the extension are configured so as to position the extension such that the extension is generally centered within the ear canal.

9. The device as recited in claim 2, wherein the extension comprises a stem having a bend formed therein so as to enhance conformance to a corresponding bend of the ear canal.

10. The device as recited in claim 2, further comprising a covering formed at least partially over the extension.

11. The device as recited in claim 2, further comprising a rubber covering formed at least partially over the extension.

12. The device as recited in claim 2, further comprising a covering formed over the extension and a gel disposed intermediate the extension and the covering.

13. The device as recited in claim 2, further comprising a covering formed over the extension and foam disposed intermediate the extension and the covering.

14. The device as recited in claim 2, wherein the extension has a bore formed therethrough so as to facilitate transmission of sound to an eardrum.

15. The device as recited in claim 2, wherein the extension has a bore formed therethrough and further comprising a filter in acoustic communication with the bore.

16. The device as recited in claim 2, wherein the extension has a bore formed therethrough and further comprising a Hoch filter in acoustic communication with the bore.

17. The device as recited in claim 2, wherein the extension is solid so as to inhibit transmission of sound to an eardrum.

18. The device as recited in claim 2, wherein the extension has a length of approximately ½ inch.

19. The device as recited in claim 2, wherein the extension has a length of at least ⅝ inch.

20. The device as recited in claim 2, further comprising a sound output port formed in a distal end of the extension, the extension being configured such that the sound output port is disposed approximately 3 millimeters from an eardrum.

21. The device as recited in claim 2, further comprising a sound output port formed in a distal end of the extension, the extension being configured such that the sound output port is disposed approximately 2 millimeters from an eardrum.

22. The device as recited in claim 2, further comprising a sound output port formed in a distal end of the extension, the extension being configured such that the sound output port is disposed approximately 1 millimeter from an eardrum.

23. The device as recited in claim 2, wherein the earpiece and the extension are formed of a material having a Shore A durometer of between approximately 35 and approximately 45.

24. The device as recited in claim 2, wherein the earpiece and the extension are formed of silicone rubber.

25. The device as recited in claim 2, wherein the earpiece and the extension are configured for use in a human ear.

26. The device as recited in claim 2, wherein the earpiece and the extension are configured for use in a canine ear

27. A device comprising:
an earpiece, the earpiece comprising:
a generally arcuate rib having upper and lower ends;
a generally straight rib extending substantially between the upper and lower ends; and
an extension formed to the earpiece.

28. The device as recited in claim 27, further comprising:
an upper lobe formed at the upper end of the arcuate rib; and
a lower lobe formed at the lower end of the arcuate rib.

29. The device as recited in claim 27, wherein the generally arcuate rib bends to accommodate a range of ear sizes.

30. The device as recited in claim 27, wherein the generally arcuate rib collapses to accommodate a range of ear sizes.

31. The device as recited in claim 27, wherein the earpiece is configured to fit most adult ears.

32. The device as recited in claim 27, wherein the earpiece is configured to fit at least 70% of ears of men between 19 and 40 years old.

33. The device as recited in claim 27, wherein the earpiece is configured to be captured by protrusions of the conchae.

34. The device as recited in claim 27, wherein the earpiece further comprises a bore formed therethrough, the bore being configured such that the extension is generally centered within the ear canal.

35. The device as recited in claim 27, wherein the earpiece is formed of a resilient polymer.

36. A method for using an earpiece, the method comprising inserting an earpiece into the conchae of an ear and inserting an extension of the earpiece into the ear canal so as to position a sound output port of the extension proximate an eardrum.

37. A method for forming a device, the method comprising:
molding an earpiece;
molding a flanged extension; and
attaching the flanged extension to the earpiece.

38. A method for forming a device, the method comprising molding an earpiece and a molding a flanged extension as an integral unit.
